(19) United States
(12) Patent Application Publication
(10) Pub. No.: US 2024/0178364 A1
(43) Pub. Date: May 30, 2024

(54) BATTERY

(71) Applicant: TOYOTA JIDOSHA KABUSHIKI KAISHA, Toyota-shi (JP)

(72) Inventors: Jun IZUMI, Toyota-shi (JP); Yusuke YAMASHITA, Kariya-shi (JP)

(73) Assignee: TOYOTA JIDOSHA KABUSHIKI KAISHA, Toyota-shi (JP)

(21) Appl. No.: 18/385,175

(22) Filed: Oct. 30, 2023

(30) Foreign Application Priority Data
Nov. 24, 2022 (JP) 2022-187802

(51) Int. Cl. H01M 4/13; H01M 10/0525; H01M 10/0585; H01M 50/46

(52) U.S. Cl. CPC H01M 4/13; H01M 10/0525; H01M 10/0585; H01M 50/46

(57) ABSTRACT

A battery has a separator, a positive electrode active material layer, a positive electrode side current collector, an adhesive layer, a negative electrode side current collector, and a negative electrode active material layer, in that order. The negative electrode side current collector has a first through-holes that are provided at a non-formation portion at which the negative electrode active material layer is not formed, and a second through-holes that are provided at the region where the negative electrode active material layer is formed. A gap is provided between the adhesive layer and the negative electrode side current collector. The gap is provided so as to communicate the first through-hole and the second through-hole.

### CROSS-REFERENCE TO RELATED APPLICATION

This application is based on and claims priority under 35 USC 119 from Japanese Patent Application No. 2022-187802 filed on Nov. 24, 2022, the disclosure of which is incorporated by reference herein.

### BACKGROUND

### Technical Field

The present disclosure relates to a battery.

### Related Art

Japanese Patent Application Laid-Open (JP-A) No. 2022-026679 discloses a structure in which, in a storage device, a second adhesive layer has a strong adhesion portion at which the distance between the valley portions of recesses and the peak portions of penetrating portions into the recesses is relatively small, and a weak adhesion portion at which the distance between the valley portions of recesses and the peak portions of penetrating portions into the recesses is relatively large. The weak adhesion portion extends so as to connect one end and another end of the edge of a joined region of the second adhesive layer.

### SUMMARY

At a battery, there are cases in which gas is generated at the negative electrode active material layer and the positive electrode active material layer. This gas collects between the negative electrode active material layer and the negative electrode side current collector, or between the positive electrode active material layer and the positive electrode side current collector, and there are cases in which separation of the layers occurs and the performances of the battery deteriorate.

To address this, Japanese Patent Application Laid-Open (JP-A) No. 2022-026679 illustrates a structure in which, in order to discharge the gas that has been generated at an active material layer, recesses are provided at the active material layer, and the weak adhesion portion is provided at the second adhesive layer, and gas is discharged. However, the recesses are formed in the surface of the active material layer, and therefore, the volumetric efficiency decreases due thereto.

An object of the present disclosure is to provide a battery at which, while a high volumetric efficiency is maintained, the collecting of gas, which is generated at a negative electrode active material layer, between the negative electrode active material layer and a negative electrode side current collector, and the collecting of gas, which is generated at a positive electrode active material layer, between the positive electrode active material layer and a positive electrode side current collector, can be suppressed.

Means for achieving the above-described object include the following aspects.
<1>
A battery including:
   a separator;
   a positive electrode active material layer;
   a negative electrode active material layer facing the positive electrode active material layer via the separator;
   a positive electrode side current collector provided at a surface, which is at a side opposite from the separator, of the positive electrode active material layer;
   a negative electrode side current collector provided at a surface, which is at a side opposite from the separator, of the negative electrode active material layer; and
   an adhesive layer provided at a surface, which is at a side opposite from the negative electrode active material layer, of the negative electrode side current collector,
   wherein the battery satisfies following structure A or following structure B:
   structure A: the negative electrode side current collector has a region a1 at which the negative electrode active material layer is not formed and a region a2 at which the negative electrode active material layer is formed, and has, at the region a1 and the region a2 respectively, one or more through-holes that pass-through from a surface at a side having the negative electrode active material layer to a surface at an adhesive layer side,
   due to a portion of the surface at the adhesive layer side of the negative electrode side current collector having a region at which the adhesive layer does not contact the negative electrode side current collector, a gap is provided between the adhesive layer and the negative electrode side current collector, and
   the gap is provided so as to communicate a through-hole provided at the region a1 and a through-hole provided at the region a2:
   structure B: the positive electrode side current collector has a region b1 at which the positive electrode active material layer is not formed and a region b2 at which the positive electrode active material layer is formed, and has, at the region b1 and the region b2 respectively, one or more through-holes that pass-through from a surface at a side having the positive electrode active material layer to a surface at the adhesive layer side,
   due to a portion of the surface at the adhesive layer side of the positive electrode side current collector having a region at which the adhesive layer does not contact the positive electrode side current collector, a gap is provided between the adhesive layer and the positive electrode side current collector, and
   the gap is provided so as to communicate the a through-hole provided at the region b1 and a through-hole provided at the region b2.
<2>
The battery of <1>, wherein the battery includes, via the separator, two cells having the negative electrode active material layer, the negative electrode side current collector, the adhesive layer, the positive electrode side current collector, and the positive electrode active material layer.
<3>
The battery of <1> or <2>, wherein:
   in a case in which the structure A is satisfied, the adhesive layer has, at a region having the gap, an adhesive layer having a height that is lower than other regions, at a surface of the positive electrode side current collector, and
   in a case in which the structure B is satisfied, the adhesive layer has, at a region having the gap, an adhesive layer having a height that is lower than other regions, at a surface of the negative electrode side current collector.
<4>
The battery of any one of <1> through <3>, wherein:
   in a case in which the structure A is satisfied, the negative electrode side current collector has a plurality of through-holes at the region a1 and has the plural through-holes at the region a2, and
   in a case in which the structure B is satisfied, the positive electrode side current collector has a plurality of through-holes at the region b1 and has a plurality of through-holes at the region b2.
<5>
The battery of any one of <1> through <3>, wherein:
   the structure A is satisfied,
   the adhesive layer has, at a region having the gap, an adhesive layer having a height that is lower than other regions, at a surface of the positive electrode side current collector, and
   the negative electrode side current collector has one or more of the through-holes at the region a1 and has one or more of the through-holes at the region a2.

In accordance with the present disclosure, there can be provided a battery at which, while a high volumetric efficiency is maintained, the collecting of gas, which is generated at a negative electrode active material layer, between the negative electrode active material layer and a negative electrode side current collector, and the collecting of gas, which is generated at a positive electrode active material layer, between the positive electrode active material layer and a positive electrode side current collector, can be suppressed.

### BRIEF DESCRIPTION OF THE DRAWINGS

Exemplary embodiments of the present invention will be described in detail based on the following figures, wherein:

FIG. 1 is a schematic sectional view illustrating a battery relating to an embodiment;

FIG. 2 is a sectional view illustrating, in an enlarged manner, a negative electrode active material layer, a negative electrode side current collector, an adhesive layer, and a positive electrode side current collector of the battery illustrated in FIG. 1;

FIG. 3 is plan view in which FIG. 2 is viewed from a thickness direction of the battery;

FIG. 4 is a plan view in which only the negative electrode side current collector in FIG. 2 is viewed from the thickness direction of the battery;

FIG. 5 is a cross-sectional view illustrating, in an enlarged manner, the adhesive layer and the positive electrode side current collector at the battery illustrated in FIG. 2; and

FIG. 6 is a plan view that is viewed from the thickness direction of the battery and illustrates places where the adhesive layer of FIG. 5 and through-holes are provided at the negative electrode side current collector.

### DETAILED DESCRIPTION

An embodiment of a battery relating to the present disclosure is described hereinafter by using the drawings.

The respective drawings described hereinafter are schematic illustrations, and the sizes and shapes of respective portions are exaggerated when appropriate in order to facilitate understanding. Further, elements that are the same or equivalent are denoted by the same reference numerals, and redundant description thereof is omitted.

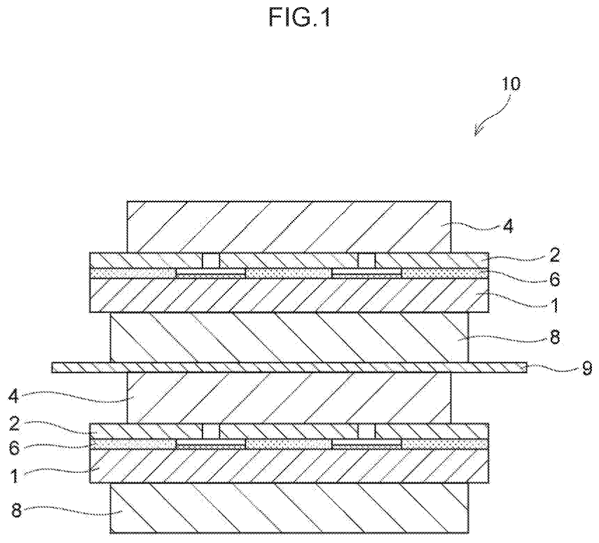

FIG. 1 is a schematic sectional view illustrating a battery relating to an embodiment. A battery 10 illustrated in FIG. 1 is a storage module used for the battery of any of various types of vehicles such as, for example, a forklift, a hybrid vehicle, an electric vehicle, or the like. The battery 10 is a secondary battery such as, for example, a nickel-hydrogen secondary battery or a lithium ion secondary battery or the like. The battery 10 may be an electric double layer capacitor, or may be a solid-state battery. So-called all-solid-state batteries using an inorganic solid electrolyte as the electrolyte are included among solid-state batteries. In the present embodiment, an example is described of a case in which the battery 10 is a lithium ion secondary battery.

The battery 10 is structured to include a cell stack (a layered body) in which plural storage cells are stacked (layered) in the thickness direction. Each of the storage cells has a positive electrode active material layer 8, a negative electrode active material layer 4 and a separator 9. The positive electrode active material layer 8 and the negative electrode active material layer 4 are respectively rectangular electrodes for example. A positive electrode side current collector 1 is provided at the surface, which is at the side opposite from the separator 9, of the positive electrode active material layer 8 so as to contact the positive electrode active material layer 8. A negative electrode side current collector 2 is provided at the surface, which is at the side opposite from the separator 9, of the negative electrode active material layer 4 so as to contact the negative electrode active material layer 4. An adhesive layer 6 is provided at the positive electrode side current collector 1 and the negative electrode side current collector 2, respectively. The positive electrode side current collector 1 and the negative electrode side current collector 2 at different storage cells are adhered together via the adhesive layer 6.

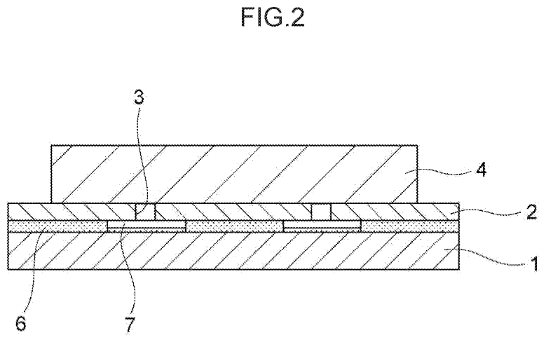

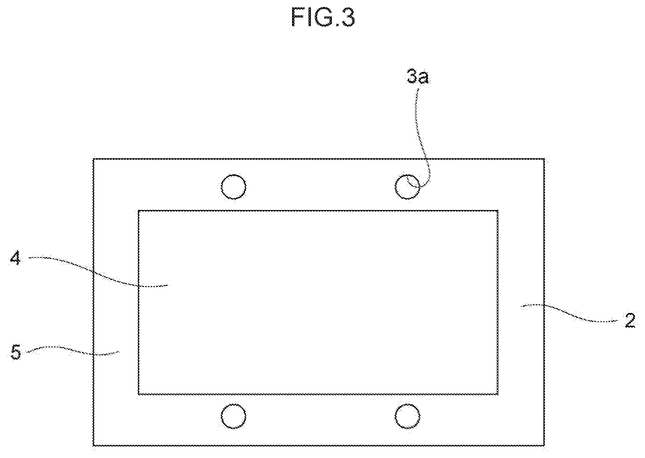

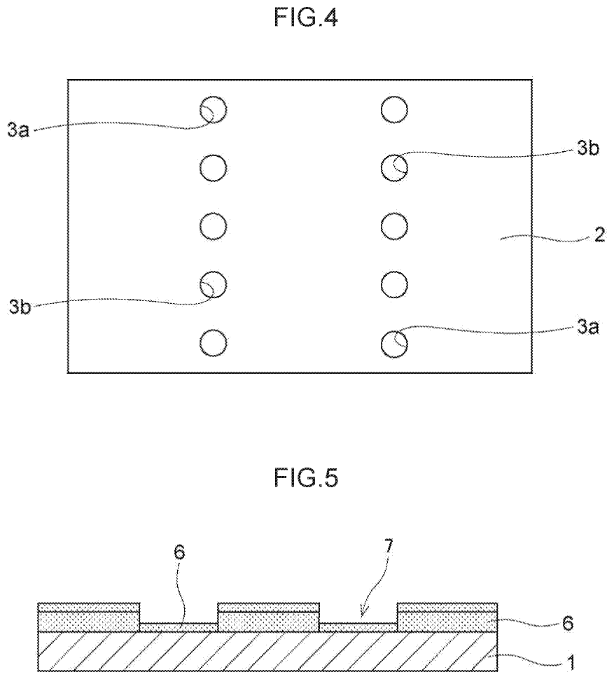

FIG. 2 is a cross-sectional view in which the negative electrode active material layer 4, the negative electrode side current collector 2, the adhesive layer 6, and the positive electrode side current collector 1 at the battery 10 of FIG. 1 are illustrated in an enlarged manner. FIG. 3 is a plan view in which FIG. 2 is viewed from the thickness direction of the battery 10. FIG. 4 is a plan view in which only the negative electrode side current collector 2 in FIG. 2 is viewed from the thickness direction of the battery 10.

Through-holes 3, which pass-through from the surface at the negative electrode active material layer 4 side to the surface at the adhesive layer 6 side are provided in the negative electrode side current collector 2. As illustrated in FIG. 3, through-holes 3a are provided at a non-formation portion 5 at which the negative electrode active material layer 4 is not formed, and, as illustrated in FIG. 4, through-holes 3b are provided at the region where the negative electrode active material layer 4 is formed.

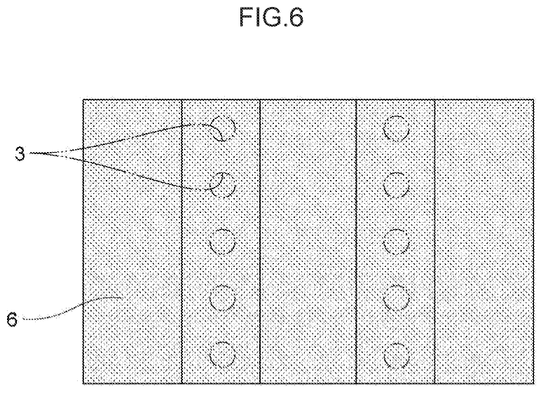

FIG. 5 is a cross-sectional view illustrating, in an enlarged manner, the adhesive layer 6 and the positive electrode side current collector 1 at the battery 10 illustrated in FIG. 2. FIG. 6 is a plan view that is viewed from the thickness direction of the battery 10, and illustrates places (see FIG. 4) where the adhesive layer 6 of FIG. 5 and the through-holes 3 are provided at the negative electrode side current collector 2.

As illustrated in FIG. 1 and FIG. 5, at the regions where the through-holes 3 are provided at the negative electrode side current collector 2, the adhesive layer 6 has regions having a height that is lower than other regions. Due to these regions of a shorter height, gaps 7 are formed between the adhesive layer 6 and the regions of the negative electrode side current collector 2 where the through-holes 3 are provided. As illustrated in FIG. 5 and FIG. 6, the gaps 7 are formed so as to be continuous from the region where the negative electrode active material layer 4 is formed to the non-formation portion 5, such that the through-holes 3a, which are provided at the non-formation portion 5 of the negative electrode side current collector 2 where the negative electrode active material layer 4 is not formed, and the through-holes 3b that are provided at the region where the negative electrode active material layer 4 is formed, both exist.

Due to this structure, the through-holes 3b, which are provided at the region of the negative electrode side current collector 2 where the negative electrode active material layer 4 is formed, communicate with the through-holes 3a, which are provided at the non-formation portion 5 of the negative electrode side current collector 2, through the gaps 7 that are provided at the regions of low height of the adhesive layer 6.

Therefore, gas that is generated at the negative electrode active material layer 4 can be discharged through the through-holes 3b, the gaps 7 and the through-holes 3a, and gas collecting between the negative electrode active material layer 4 and the negative electrode side current collector 2 can be suppressed.

Japanese Patent Application Laid-Open (JP-A) No. 2022-026679 discloses a structure in which, in order to discharge gas that is generated at an active material layer, recesses are provided in the active material layer, and a weak adhesion portion is provided at the second adhesive layer, and the gas is discharged. However, in the battery 10 relating to the embodiment of the present disclosure, gas can be discharged through the through-holes 3b, the gaps 7 and the through-holes 3a, without providing recesses in the negative electrode active material layer 4. Namely, without reducing the volume of the negative electrode active material layer 4, high volumetric efficiency can be realized, and gas can be discharged.

### (Through-Holes)

FIG. 3 and FIG. 4 illustrate a structure in which four of the through-holes 3a are provided at the non-formation portion 5 of the negative electrode side current collector 2 at which the negative electrode active material layer 4 is not formed, and six of the through-holes 3b are formed at the region where the negative electrode active material layer 4 is formed. However, the present disclosure is not limited to this, and it suffices for one or more of the through-holes 3a to be provided at the non-formation portion 5 of the negative electrode side current collector 2, and for one or more of the through-holes 3b to be provided at the region where the negative electrode active material layer 4 is formed. However, from the standpoint of improving the gas discharging ability, it is preferable that two or more (and more preferably four or more) of the through-holes 3a be provided in the non-formation portion 5 of the negative electrode side current collector 2, and two or more (more preferably six or more) of the through-holes 3b be provided at the region where the negative electrode active material layer 4 is formed.

### (Gaps)

It suffices for the gaps 7 to be formed such that the through-holes 3a, which are provided at the non-formation portion 5 of the negative electrode side current collector 2 where the negative electrode active material layer 4 is not formed, and the through-holes 3b, which are provided at the region where the negative electrode active material layer 4 is formed, communicate with one another. Namely, all of the through-holes 3a that are provided in the non-formation portion 5 of the negative electrode side current collector 2 communicate, through the gaps 7, with the through-holes 3b that are provided at the region where the negative electrode active material layer 4 is formed. FIG. 5 and FIG. 6 illustrate a structure in which two of the gaps 7 are provided at the adhesive layer 6. However, the present disclosure is not limited to this, and there may be one gap 7. In this case, all of the through-holes 3a provided in the non-formation portion 5 and all of the through-holes 3b provided at the region where the negative electrode active material layer 4 is formed communicate through the one gap 7. Further, two or more of the gaps 7 may be provided, or three or more of the gaps 7 may be provided.

As illustrated in FIG. 5, at the regions where the gaps 7 are provided, the adhesive layer 6 having a height that is lower than (whose thickness is thinner than) other regions is formed on the surface of the positive electrode side current collector 1. Due thereto, due to the adhesive layer 6 that is thin working as a lithium corrosion resistant film, corrosion of the aluminum foil is suppressed, and a deterioration in the stability of the operations of the storage device at the reaction potential of the negative electrode active material is suppressed. From this standpoint, in the present disclosure, it is preferable to form the adhesive layer 6, whose height is lower (whose thickness is thinner) than other regions, on the surface of the positive electrode side current collector 1 also at the regions where the gaps 7 are provided.

### Modified Example

FIG. 1 through FIG. 6 illustrate the battery 10 that has a structure (i.e., structure A) in which the negative electrode side current collector 2 has a region a1 at which the negative electrode active material layer 4 is not formed and a region a2 at which the negative electrode active material layer 4 is formed, and has, at the region a1 and the region a2 respectively, one or more through-holes that pass-through from the surface at the side having the negative electrode active material layer 4 to the surface at the adhesive layer 6 side, and a portion of the surface at the adhesive layer 6 side of the negative electrode side current collector 2 has a region at which the adhesive layer 6 does not contact the negative electrode side current collector 2, and due thereto, the gap 7 is provided between the adhesive layer 6 and the negative electrode side current collector 2, and the gap 7 is provided such that the through-hole 3a provided at the region a1 and the through-hole 3b provided at the region a2 communicate.

However, in the present disclosure, the through-hole may be provided in the positive electrode side current collector. Namely, the battery may have a structure (i.e., structure B) in which the positive electrode side current collector has a region b1 at which the positive electrode active material layer is not formed and a region b2 at which the positive electrode active material layer is formed, and has, at the region b1 and the region b2 respectively, one or more through-holes that pass-through from the surface at the side having the positive electrode active material layer to the surface at the adhesive layer side, and a portion of the surface at the adhesive layer side of the positive electrode side current collector has a region at which the adhesive layer does not contact the positive electrode side current collector, and due thereto, a gap is provided between the adhesive layer and the positive electrode side current collector, and the gap is provided such that the through-hole provided at the region b1 and the through-hole provided at the region b2 communicate.

The battery that has this structure B has a structure in which the through-hole, which is provided at the region of the positive electrode side current collector where the positive electrode active material layer is formed, communicates with the through-hole provided in the non-formation portion of the positive electrode side current collector, through the gap that is provided at a region of the adhesive layer where the height is low. Therefore, gas generated at the positive electrode active material layer can be discharged through the through-hole provided at the region b2, the gap, and the through-hole provided at the region b1, and gas collecting between the positive electrode active material layer and the positive electrode side current collector can be suppressed.

Note that a preferable aspect of the through-hole, a preferable aspect of the gap, and a preferable aspect of the adhesive layer at the gap in structure B are similar to those in the case of the structure illustrated in FIG. 1 through FIG. 6 (i.e., structure A).

(Members that Structure Battery)

The positive electrode side current collector 1 and the negative electrode side current collector 2 are chemically inert electric conductors for causing current to continue to flow to the positive electrode active material layer 8 and the negative electrode active material layer 4 during discharging or charging of the lithium ion secondary battery.

For example, metal materials, conductive resin materials, conductive inorganic materials, and the like can be used as materials that structure the positive electrode side current collector and the negative electrode side current collector. Examples of conductive resin materials are resins in which a conductive filler is added as needed to a conductive polymer material or a non-conductive polymer material, and the like. The positive electrode side current collector and the negative electrode side current collector may have plural layers including one or more layers containing the aforementioned metal materials or conductive resin materials. A coating layer may be formed on the surfaces of the positive electrode side current collector and the negative electrode side current collector by a known method such as plating, spray coating, or the like. The positive electrode side current collector and the negative electrode side current collector may be formed in form such as, for example, a plate, a foil, a sheet, a film, a mesh, or the like. In a case in which the positive electrode side current collector and the negative electrode side current collector are metal foils, for example, aluminum foil, copper foil, nickel foil, titanium foil, stainless steel foil or the like can be used. In the present embodiment, the positive electrode side current collector is an aluminum foil, and the negative electrode side current collector is a copper foil. In the case of using a current collector that is in the form of a foil, the thickness thereof may be 1 μm to 100 μm for example.

The positive electrode active material layer contains a positive electrode active material that can store and release the charge carrier such as lithium ions or the like. As the positive electrode active material, it suffices to employ a material that can be used as the positive electrode active material of a lithium ion secondary battery, such as a lithium composite metal oxide having a laminar rock salt structure, a metal oxide having a spinel structure, a polyanion compound, or the like. Further, two or more positive electrode active materials may be used in combination. In the present embodiment, the positive electrode active material layer contains an olivine-type lithium iron phosphate (LiFePO₄) that is a composite oxide.

The negative electrode active material layer is not particularly limited, and any of a simple substance, an alloy or a compound may be used provided that it can store and release the charge carrier such as lithium ions or the like. For example, Li, or carbon, a metal compound, a metal that can be alloyed with lithium, or compounds thereof and the like are examples of the negative electrode active material. Examples of the carbon are natural graphite, artificial graphite, hard carbon (hard graphitized carbon), and soft carbon (soft graphitized carbon). Examples of artificial graphite are highly oriented graphite, mesocarbon microbeads, and the like. Examples of elements that can be alloyed with lithium are silicon and tin. In the present embodiment, the negative electrode active material layer contains graphite that is a carbon-based material.

The positive electrode active material layer and the negative electrode active material layer may respectively further contain a conduction assistant for improving the electrical conductivity, a binder, an electrolyte (a polymer matrix, an ion-conductive polymer, an electrolyte liquid, or the like), an electrolyte supporting salt (lithium salt) for improving the ion conductivity, and the like. The components contained in the positive electrode active material layer and the negative electrode active material layer, the compounding ratios of these components, and the thicknesses of the positive electrode active material layer and the negative electrode active material layer are not particularly limited, and appropriate reference can be made to conventionally known information relating to lithium ion batteries. The thicknesses of the positive electrode active material layer and the negative electrode active material layer are, for example, 2 μm to 150 μm. A conventionally known method such as roll coating or the like may be used to form the positive electrode active material layer and the negative electrode active material layer on the surface of a current collector. In order to improve the thermal stability of the positive electrode active material layer or the negative electrode active material layer, a heat-resistant layer may be provided at the surface (one surface or both surfaces) of the positive electrode side current collector or the negative electrode side current collector, or on a surface of the positive electrode active material layer or the negative electrode active material layer. The heat-resistant layer contains inorganic particles and a binder for example, and in addition thereto, may include additives such as a thickener and the like.

The conduction assistant is added in order to improve the conductivity of the positive electrode active material layer 8 or the negative electrode active material layer 4. Examples of the conduction assistant are acetylene black, carbon black, graphite and the like.

Examples of the binder are fluorine-containing resins such as polyvinylidene fluoride, polytetrafluoroethylene, fluororubber, or the like, thermoplastic resins such as polypropylene, polyethylene and the like, imide resins such as polyimide, polyamide-imide and the like, alkoxysilyl group-containing resins, acrylic resins such as poly(meth)acrylic acid and the like, styrene-butadiene rubber (SBR), carboxymethyl cellulose, alginates such as sodium alginate, ammonium alginate and the like, water-soluble cellulose ester crosslinked bodies, and starch-acrylic acid graft polymer. A single one of or plural types of these binders can be used. For example, water, N-methyl-2-pyrrolidone (NMP), or the like can be used as the solvent.

The separator 9 is disposed between the positive electrode active material layer 8 and the negative electrode active material layer 4, and is a member that allows passage of the charge carrier such as lithium ions or the like while, by separating the positive electrode active material layer 8 and the negative electrode active material layer 4, suppressing short-circuiting due to contact of the both electrodes. The separator 9 prevents short circuiting between bipolar electrodes that are adjacent to one another at the time when storage cells are stacked.

The separator may be, for example, a porous sheet or a non-woven material containing a polymer that absorbs and retains an electrolyte. Examples of the material that structures the separator are polypropylene, polyethylene, polyolefin, polyester and the like. The separator may be a single-layer structure or a multi-layer structure. A multi-layer structure may have, for example, an adhesive layer, a ceramic layer that serves as a heat-resistant layer, and the like. The separator may be impregnated with the electrolyte, or the separator itself may be structured by an electrolyte such as a polymer electrolyte, an inorganic electrolyte, or the like.

Examples of the electrolyte with which the separator 9 is impregnated are a liquid electrolyte (electrolyte liquid) containing a non-aqueous solvent and an electrolyte salt that dissolves in a non-aqueous solvent, a polymer gel electrolyte containing an electrolyte held in a polymer matrix, and the like.

In a case in which the separator 9 is impregnated with an electrolyte, a known lithium salt such as LiClO₄, LiAsF₆, LiPF₆, LiBF₄, LiCF₃SO₃, LIN(FSO₂)₂, LIN(CF₃SO₂)₂ or the like can be used as the electrolyte salt. Further, a known solvent that is a cyclic carbonate, a cyclic ester, a chain carbonate, a chain ester, an ether or the like can be used as the non-aqueous solvent. Note that two or more types of these known solvent materials may be used in combination.

### (Method of Fabrication)

An example of the method of fabricating the battery 10 relating to the embodiment of the present disclosure is described here.

First, the through-holes 3 are formed in the negative electrode side current collector 2. The through-holes 3 are formed so as to pass-through from the surface, which is at the side at which the negative electrode active material layer 4 is formed, of the negative electrode side current collector 2 to the surface that is at the side at which the adhesive layer 6 is formed. As the through-holes 3, the through-holes 3a are formed in the non-formation portion 5 of the negative electrode side current collector 2 where the negative electrode active material layer 4 is not formed, and the through-holes 3b are formed at the region where the negative electrode active material layer 4 is formed. Examples of the method of forming the through-holes 3 are punching processing, laser processing and the like.

Next, the negative electrode active material layer 4 may be formed by coating and hardening a coating material for forming the negative electrode active material layer 4 on one surface of the negative electrode side current collector 2 in which the through-holes 3 are formed. Note that it is preferable to make it such that the coating material does not flow-out from the through-holes 3, and to this end, for example, the viscosity of the coating material may be increased.

Next, the positive electrode side current collector 1, on whose one surface the positive electrode active material layer 8 has been formed, is prepared, and the adhesive layer 6 is formed on the another surface of the positive electrode side current collector 1. Note that the forming of the adhesive layer 6 can be carried out by, for example, coating an adhesive over two times. For example, an adhesive of a first time is coated except for on the regions where the gaps 7 are to be formed, and then an adhesive of a second time is coated on the entire surface such that the coated amount is thinner than that of the first time. Due thereto, only the adhesive of the second time is coated on the regions where the gaps 7 are to be formed, and the adhesives of the first time and the second time are coated on the other regions. Therefore, the height of the adhesive layer at the regions where the gaps 7 are formed is lower than at other regions, and the gaps 7 are formed. Examples of a method for the first-time coating of an adhesive except for at the regions where the gaps 7 are to be formed are a method of selectively coating the adhesive, a method of masking the regions where the gaps 7 are to be formed and then coating the adhesive on the entire surface, and the like.

Next, the positive electrode side current collector 1 and the negative electrode side current collector 2 are affixed together via the adhesive layer 6. At the time of affixing, adjustment is carried out such that the through-holes 3 provided in the negative electrode side current collector 2 are disposed at the positions of the gaps 7 provided at the adhesive layer 6. Due thereto, a storage cell having a layered structure of the negative electrode active material layer 4/the negative electrode side current collector 2/the adhesive layer 6/the positive electrode side current collector 1/the positive electrode active material layer 8 is obtained.

Note that the forming of the positive electrode active material layer 8 and the negative electrode active material layer 4 can be carried out after the positive electrode side current collector 1 and the negative electrode side current collector 2 are affixed via the adhesive layer 6.

Thereafter, due to the storage cells, which have the negative electrode active material layer 4, the negative electrode side current collector 2, the adhesive layer 6, the positive electrode side current collector 1 and the positive electrode active material layer 8, being stacked via the separators 9, the battery 10 is fabricated.

Note that, also in a case of fabricating the battery having a structure in which the through-holes are provided in the positive electrode side current collector (i.e., the above-described structure B), the battery can be fabricated by providing the through-holes in the positive electrode side current collector and providing the gaps in the adhesive layer that is at the surface side of the positive electrode side current collector, in accordance with the above-described fabrication method.

What is claimed is:

1. A battery comprising:
a separator;
a positive electrode active material layer;
a negative electrode active material layer facing the positive electrode active material layer via the separator;
a positive electrode side current collector provided at a surface, which is at a side opposite from the separator, of the positive electrode active material layer;
a negative electrode side current collector provided at a surface, which is at a side opposite from the separator, of the negative electrode active material layer; and
an adhesive layer provided at a surface, which is at a side opposite from the negative electrode active material layer, of the negative electrode side current collector,
wherein the battery satisfies following structure A or following structure B:
structure A: the negative electrode side current collector has a region a1 at which the negative electrode active material layer is not formed and a region a2 at which the negative electrode active material layer is formed, and has, at the region a1 and the region a2 respectively, one or more through-holes that pass-through from a surface at a side having the negative electrode active material layer to a surface at an adhesive layer side,
due to a portion of the surface at the adhesive layer side of the negative electrode side current collector having a region at which the adhesive layer does not contact the negative electrode side current collector, a gap is provided between the adhesive layer and the negative electrode side current collector, and
the gap is provided so as to communicate a through-hole provided at the region a1 and a through-hole provided at the region a2;
structure B: the positive electrode side current collector has a region b1 at which the positive electrode active material layer is not formed and a region b2 at which the positive electrode active material layer is formed, and has, at the region b1 and the region b2 respectively, one or more through-holes that pass-through from a surface at a side having the positive electrode active material layer to a surface at the adhesive layer side,
due to a portion of the surface at the adhesive layer side of the positive electrode side current collector having a region at which the adhesive layer does not contact the positive electrode side current collector, a gap is provided between the adhesive layer and the positive electrode side current collector, and
the gap is provided so as to communicate the a through-hole provided at the region b1 and a through-hole provided at the region b2.

2. The battery of claim 1, wherein the battery includes, via the separator, two cells having the negative electrode active material layer, the negative electrode side current collector, the adhesive layer, the positive electrode side current collector, and the positive electrode active material layer.

3. The battery of claim 1, wherein:
in a case in which the structure A is satisfied, the adhesive layer has, at a region having the gap, an adhesive layer having a height that is lower than other regions, at a surface of the positive electrode side current collector, and
in a case in which the structure B is satisfied, the adhesive layer has, at a region having the gap, an adhesive layer having a height that is lower than other regions, at a surface of the negative electrode side current collector.

4. The battery of claim 1, wherein:
in a case in which the structure A is satisfied, the negative electrode side current collector has a plurality of through-holes at the region a1 and has a plurality of through-holes at the region a2, and
in a case in which the structure B is satisfied, the positive electrode side current collector has a plurality of through-holes at the region b1 and has a plurality of through-holes at the region b2.

5. The battery of claim 1, wherein:
the structure A is satisfied,
the adhesive layer has, at a region having the gap, an adhesive layer having a height that is lower than other regions, at a surface of the positive electrode side current collector, and
the negative electrode side current collector has one or more of the through-holes at the region a1 and has one or more of the through-holes at the region a2.
